(19) United States
(12) Patent Application Publication
(10) Pub. No.: US 2017/0126940 A1
(43) Pub. Date: May 4, 2017

(54) PORTABLE SURVEILLANCE SYSTEM

(71) Applicant: B and D Technologies LLC, Troy, OH (US)

(72) Inventors: David E. Yount, Troy, OH (US); Robert Yount, Troy, OH (US)

(21) Appl. No.: 15/343,162

(22) Filed: Nov. 3, 2016

Related U.S. Application Data
(60) Provisional application No. 62/250,034, filed on Nov. 3, 2015.

(51) Int. Cl. H04N 5/225; H04N 5/77; H04N 5/907; H04N 7/18; H04N 5/232

(52) U.S. Cl. CPC H04N 5/2252; H04N 7/185; H04N 5/23293; H04N 5/907; H04N 5/77

(57) ABSTRACT

A surveillance apparatus includes a housing, a cellular modem, one or more cameras coupled to a video processor/server, an input/output device, and a power source. The cellular modem is coupled to the housing. An antenna is coupled to the modem. One or more cameras are coupled to the video processor/server for capturing data from the one or more cameras. The video processor/server is coupled to the modem to permit the transmission of data therefrom. A plurality of external connectors are coupled to the housing and the video processor/server. The power source is for powering the cellular modem and the video processor/server. The surveillance apparatus permits a user to monitor a location remotely using the cellular modem.

### CROSS-REFERENCE TO RELATED APPLICATION

This application claims priority to U.S. Provisional Application No. 62/250,034, filed on Nov. 3, 2015, the disclosure of which is incorporated herein by reference in its entirety.

### FIELD

The technology described herein concerns a portable surveillance system.

### BACKGROUND

Law enforcement requires ways to surveil areas. Typically, an officer will sit in a patrol car and monitor an area. This can result in a waste of valuable man power. It is desirable to be able to surveil an area without being physically present, particularly when man power is an issue.

First responders and disaster responders desire situational awareness of an area. Greater situational awareness translates to greater safety for responders, since they have more information and data available to avoid or deter disasters. Typically, a responder in the field will receive information from a supervisor or post that is remote from the responder's location. Oftentimes the data may not be up-to-date.

### SUMMARY

A surveillance apparatus is shown and described.

### BRIEF DESCRIPTION OF THE DRAWINGS

FIG. 1 depicts an image of an example portable surveillance device according to the invention;

FIG. 2 depicts a left side view of the example portable surveillance device of FIG. 1 with various connectors displayed;

FIG. 3 depicts a right-side view of the example portable surveillance device of FIG. 1 with various connectors displayed;

FIG. 4 depicts a power cord that can be used to provide power to the portable surveillance device of FIG. 1;

FIG. 5 depicts example power terminals for use with the device of FIG. 1;

FIG. 6 depicts a circuit diagram of the power input to the example device of FIG. 1;

FIG. 7 depicts a circuit diagram of a video processor/server for use with the example device of FIG. 1;

FIG. 8 depicts an example modem for use with the example device of FIG. 1;

FIG. 9 depicts an exterior view of a housing that can be used with the example device of FIG. 1;

FIG. 10 depicts an interior view of the housing of FIG. 9 with various parts of the housing cut away;

FIG. 11 depicts an interior view of the housing of FIG. 10 with a liner installed in the housing and with a first layer of components installed therein;

FIG. 12 depicts an interior view of the housing of FIG. 11 with additional components installed therein;

FIG. 13 depicts a left connector plate utilized with the housing of FIG. 9;

FIG. 14 depicts the connector plate of FIG. 3 after apertures have been cut into the plate for various connectors;

FIG. 15 depicts the connector plate of FIG. 14 with a vinyl overlay and with the various connectors attached to the plate;

FIG. 16 depicts a right connector plate utilized with the housing of FIG. 9;

FIG. 17 depicts the right connector plate of FIG. 16 after apertures have been cut into the plate;

FIG. 18 depicts the right connector plate of FIG. 17 after a vinyl overlay has been applied to the plate and with connectors installed thereon;

FIG. 19 depicts an interior view of the housing of FIG. 12 with additional components installed therein;

FIG. 20 depicts an interior view of the housing of FIG. 19 with additional components installed therein; and

FIG. 21 depicts an interior view of the housing of FIG. 20 with additional components installed therein.

### DETAILED DESCRIPTION

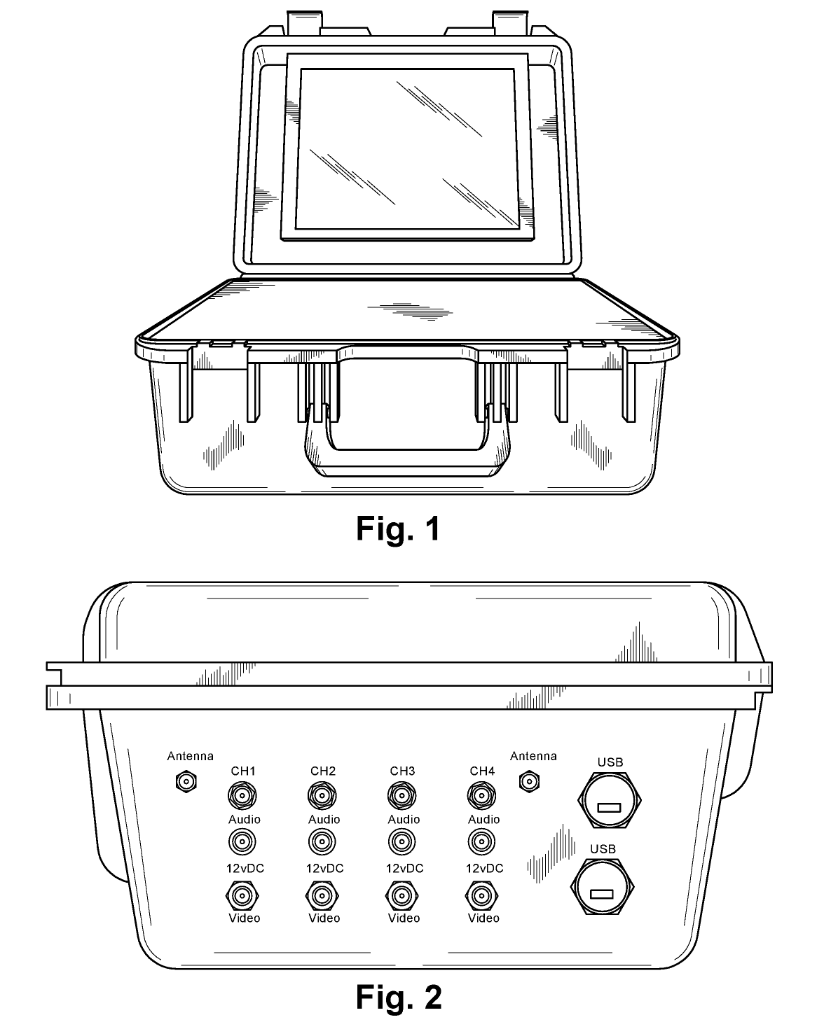

The example system shown in FIGS. 1-21 can be used by anyone needing situational awareness or the ability to record activities in a remote location. For example, the system permits law enforcement to use their own cell phones to view a scene, which provides for better situational awareness. The system permits law enforcement to minimize use of radios and to maximize use of smart technology. The example system includes a video processor and is a server. It takes video using cameras that are coupled to the unit and feeds the video to something else, such as a remote viewing device. Remote viewing devices can be anything that utilizes cellular data. The video is fed through cellular modem to the cellular network. Images can be selected and users can connect and view the images that the cameras record and see.

Another example where the present system is useful is in the case of first responders. The system permits disaster responders to have more situational awareness during a disaster. Greater situational awareness translates into greater safety for responders, since they have more information and data available to avoid or deter disasters. Others, in addition to first responders have access to the video images and/or audio associated with the images. This permits the responders to have assistance from experts or others who can lend additional knowledge while not being present at the scene.

The same is true in the context of law enforcement. Others can view images and video even though they are positioned at remote locations. This may aid the users in identifying suspects or thwarting illegal activities.

The situation provides the users with greater situational awareness than previously possible. The system provides instant real time access to all video feeds utilizing a portable 12V DC device. The device can be powered with any number of different power sources, including being plugged into a cigarette lighter, plugged into a wall outlet, or run off a battery. The system is adaptable and can be modified to fit may different applications. For example, the system can be utilized in the maritime setting, by police or fire personnel, or by search and rescue, as well as others. The system may utilize a single camera or more cameras, if desired. The examples shown herein can utilize up to 8 cameras. However, the system can be modified to utilize any number of cameras between 1 and 8 or greater than 8.

The system can provide video in color, black and white, infrared, or thermal imagery. The system provides remote viewing via any number of different devices that can accept data via a cellular network, such as any phone, PC, or tablet. Other types of networks may be utilized to transmit data, if desired. For example, hard-wired systems could be utilized, such as cable systems, as well as other hard-wired or non-hard-wired systems. The video content and data can be view using Android, Apple, And Windows applications. The system can control PTZ (Pan-tilt-zoom) capable cameras using a remote device. The system may include cameras that provide pan, tilt, and/or zoom, as well as other camera features known by those of skill in the camera art.

The system permits users to record to their local viewing device or to take snapshots of sections of the video. The main unit of the system records at all times and data can be downloaded from the main unit, if desired. The system may permit a user to search the record history of the main unit remotely and instantly. The system may also permit download of all video history from the main unit remotely or on site using a USB thumb drive. Cameras can be controlled from inside a vehicle that they are mounted to via the main unit. Alternatively, remotely located cameras can be operated via instructions to and from the main unit. The system provides 4G streaming. As cellular networks are improved, the system will be capable of utilizing other types of improved streaming. Any number of users may utilize the system. For example, it is possible to assign up to 9 users, all having rights to view remotely. Any number of users may be assigned with appropriate software and hardware. The system may also provide audio capability, so that it is possible to both see and hear what is going on in the field. Audio can be transmitted remotely via the system in the same way that video is transmitted, or as a separate feed.

The system is a portable device that uses a camera that is connected to a video processor/server, which is coupled to a cellular modem. The cellular modem transmits data via a cellular network so that remote users, such as law enforcement, can get information about an operation on their cell phones and tablets. The device has a built-in video monitor and is coupled to one or more cameras. The cameras may have pan, tilt, and zoom controls that may be controlled remotely or from the device itself. The device provides instant video play back to phones/tablets/PC's or other types of remote devices. It allows the operator to see what is going on in real time. The user can record images and video to their remote devices or to their PC. The device also records locally to a solid state hard drive, which can be programmed to record at all times, only when motion is detected, or when directed to record by a user.

There are at least three power options that provide a power source to the device. One power option is an internal battery that allows the device to run for 12 hours while powering 4 cameras, for example. Another power option is to plug the unit into a 12v cigarette lighter or a 12v wall adapter. Alternatively, the device can have a power cord that can be plugged into a 120v wall outlet.

The device can be controlled locally by a USB mouse by entering commands on the monitor. The device may include two USB ports that can off load the data to an external USB hard drive or thumb drive. The device uses QR reader technology to automatically download software to the remote device. Remote devices may be coupled to the device with QR reader technology or by other know technology. To set up the device and to couple the device to remote viewing devices, the main device must be turned on and be physically in front of the remove viewing device. The user scans a QR code that is displayed on the monitor (control panel), which will take the user to a link to download the software that is used to couple the remote viewing device to the main device. Once the software is installed, the user can re-scan the QR code to program the remote viewing device. The QR Code includes the encrypted id of the unit. Each unit has its own unique QR code.

The example surveillance device can be effectively used for undercover operations by law enforcement. For example, the system can be wired to a vehicle with cameras hidden in the vehicle in such places as pillars or vents. Wires can run from the cameras to a location in the vehicle, such as the trunk, where the wires are plugged into the device. The system permits other officers to watch live and remotely what is going on in the car and surrounding the car.

The portable surveillance device includes a housing in the form of a hard case. A 15″ monitor may be installed on the housing, such as being placed inside the lid of the case. The device includes a battery, DVR, and cellular modem in a bottom tray of the housing. The bottom tray may be an actual tray, or could be a bottom layer of components inside the housing. The device may include two bus bars, one for 12vDC+ and one for 12vDC−. The buses distribute power from the power source to the components of the device.

The system and portable surveillance device includes connectors on left and right end plates. The connectors may be coupled to bulkhead extension cables that are connected to the DVR, modem, and 12v for powering the cameras. The unit device may include one or more fans. When two fans are used, one is used for pushing air and the other is used for pulling air. A filter can be utilized with the fans. The fans are used for cooling components inside the housing.

The system may include a battery monitor, such as a battery monitor LCD on the side plate of the device to show the voltage of the internal battery. A switch may be provided to turn the battery monitor off, if desired. A power switch may be provided on one of the side panels of the housing to power the device on and off and to power the monitor on and off. The monitor may be a 15″ LCD monitor, or another size or type of monitor. The monitor does not need to be on when the surveillance device is in use and in the trunk of a vehicle.

A battery charger may be included with the device. An example charger is a 1.5 amp per hour charger.

The example surveillance device uses cellular technology to transmit video from a DVR remotely. It is an all-in-one unit. It is portable and does not require an external power source. It has built in power for the cameras and can also transmit live audio with the video feed. It is especially designed for law enforcement and allows for customization based upon the needs of law enforcement.

A wireless version of the system uses wireless cameras that operate on batteries. The wireless cameras can be positioned anywhere, such as within 150 feet of the main device, to transmit video back to the main device. Then the main device allows users to access the video feed from anywhere with a cellular signal or internet connection.

As previously discussed, the system can also be used by emergency responders, where thermal and video imaging can be utilized. In this case, the system uses a camera that is connected to a video processor/server, which is coupled to a cellular modem. The cellular modem transmits data via a cellular network so that emergency responders can get information about a particular disaster on their cell phones and tablets.

In remote areas, a portable cellular network can be set up, such as a C.O.W. (Cellular on wheels), to permit the responders to view thermal and video images on their cell phones and tablets. Cameras can be positioned on trucks (such as fire trucks) and automobiles. Cameras can also be carried in and mounted in the field, can be put on cell towers, or can be carried on a person's body.

As an example, the system could be used by hot shot firefighters to have better awareness of the location of the fire around them. They would be able to use their cell phones to track the location of the fire and of their colleagues, instead of having to rely on instructions from supervisors or command centers, who may not know their exact location. The main device may also include GPS components and software that permits the device to be tracked. In addition, remote devices may also include GPS technology that permits the main unit to determine a location of the remote device and the user of the device. As with the previously described example utilized by law enforcement, the unit has a built-in video monitor, and pan, tilt, and zoom controls that may be controlled remotely or from a vehicle. The main device provides instant video play back to phones/tablets/PC's. The main device permits relevant data to be pulled up in the vicinity of the responders, which, in turn, permits the responders to have greater situational awareness.

As previously discussed, any number of users may utilize the system. For example, it is possible to assign up to 32 users, all having rights to view remotely. The main device may be GPS enabled so you can always find the Unit, or the vehicle it is positioned in, via application. The main device may also provide audio capability, so that it is possible to both see and hear what is going on in the field.

The system may include other features in addition to those described above. The system may record video and/or audio to a hard drive, or can take time lapse snapshots. A fire truck or police car could have a thermal camera on the truck so that those at remote locations can see what firefighters or police see. This would also permit a person who is in route to see what is happening on the scene. This technology could be used with windshield surveys and in search and rescue. Thermal images have a heat signature, which would be useful in this context.

If cellular networks are down, the system could use SATCOM. Cameras could be set up on hill tops or dropped by parachute. The range of any cameras would be dependent upon the type of lens utilized. The field of range for the cameras is also a function of the type of lens, with some lenses being longer range, but smaller field of view, for example.

The system permits responders to use their own cell phones to view the scene, which provides for better situational awareness. Vehicles can be used as mobile hot spots to provide wireless service to responders. The system permits responders to minimize use of radios and to maximize use of smart technology. The system could also be utilized to monitor biometrics of responders.

An example of the system is shown in FIG. 1. The main device is shown as including a housing in the form of a case. A 15″ LCD is coupled to an inner surface of the housing for live, in vehicle, on site control and monitoring. The case is durable and made to take rough handling. Other types of screens or case designs/shapes could be used. FIG. 1 depicts a screen shot of the video feed shown on the LCD screen. The housing includes a top part and a bottom part that are coupled together with a hinge. The top and bottom parts of the housing may be closed and held shut with coupling device, like latches. The LCD screen is shown attached to an inner surface of the top part of the housing, but could be positioned on a different surface. The LCD could also be removable from the housing and could wirelessly communicate with the components of the housing. A cover is positioned over a top surface of the bottom part of the housing. The cover is used to protect components that underlie the cover.

FIG. 2 depicts a connector plate that is positioned on a left side of the housing. Four channels are provided that include audio, video and power connectors. Four connectors are provided for video and are used for hooking up video feeds from the cameras. There are four (4) Audio inputs that are used for receiving audio input from the cameras. There are four (4) 12v DC outputs for powering cameras that are wired to the device. Alternatively, cameras could be wirelessly connected to the device. The 12v DC connectors are used to power the cameras. Two (2) connectors are labeled “Antenna” and are used for coupling antennas to the cellular modem. Two (2) inputs are labeled USB and are provided for connecting a USB mouse to the device and/or for coupling an external hard drive or thumb drive to off load saved video. The connectors shown are bulk head connectors. They include BNC, USB and other connector heads. Other types of connectors can be used, if desired.

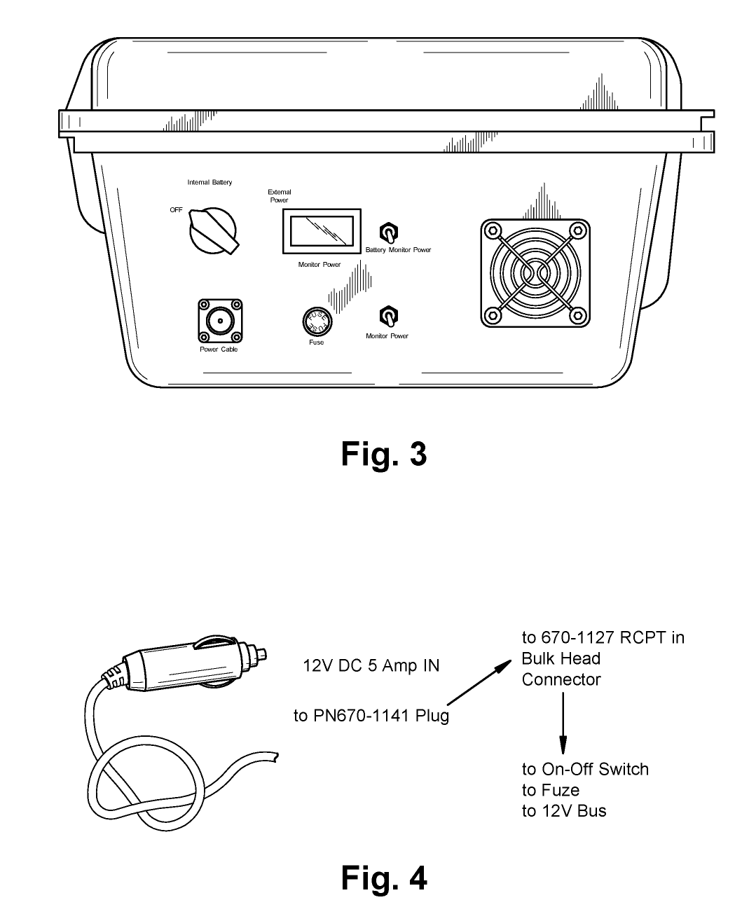

FIG. 3 depicts a right-side view of the housing and a connector plate that is coupled to the right side of the housing. The connector plate includes a power selector switch, a fuse holder, a power input connector, a battery monitor power switch, an LCD monitor power switch, and a 2″ fan with guard.

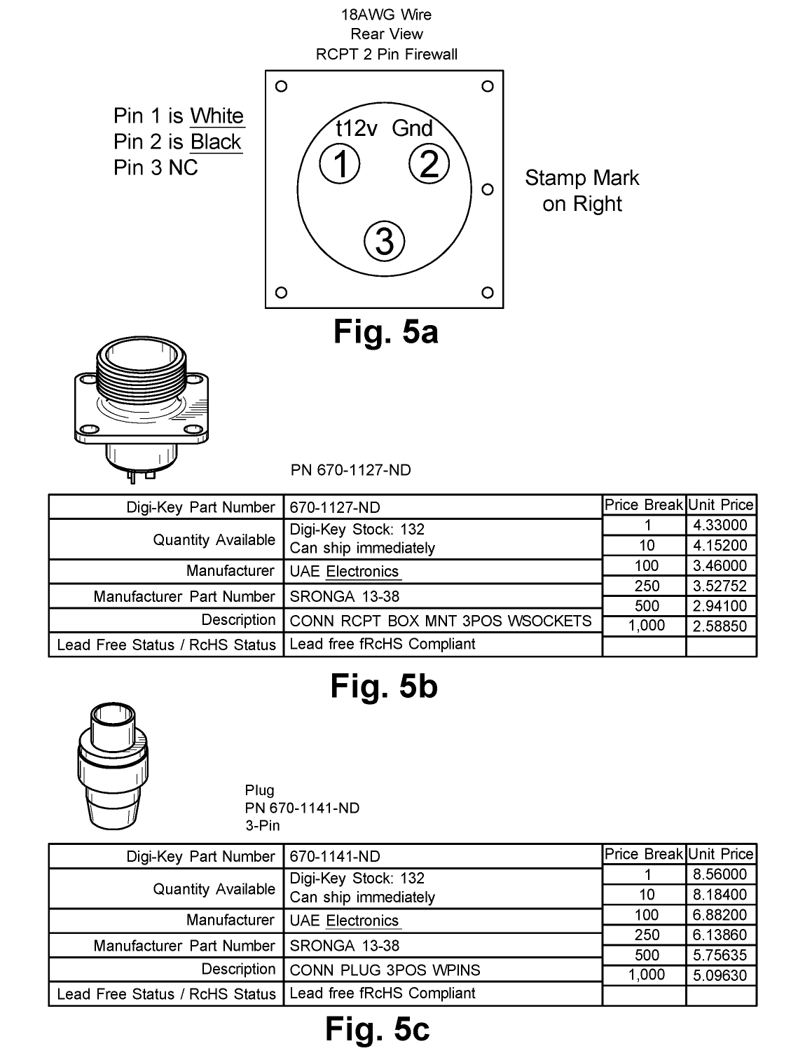

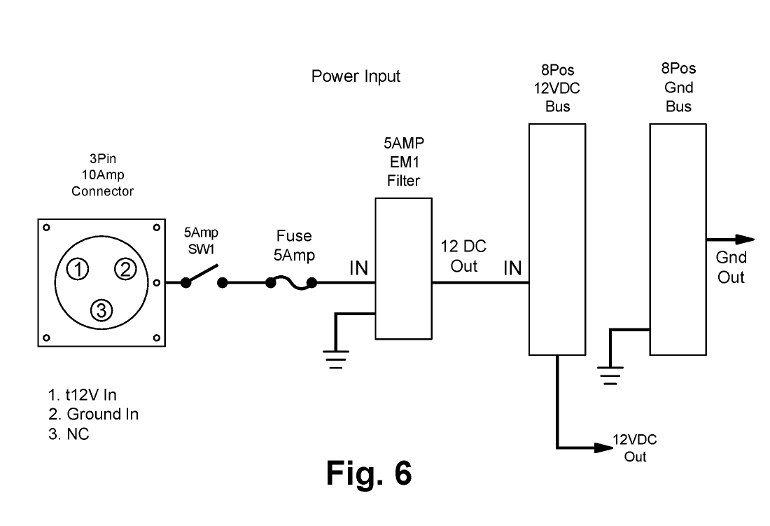

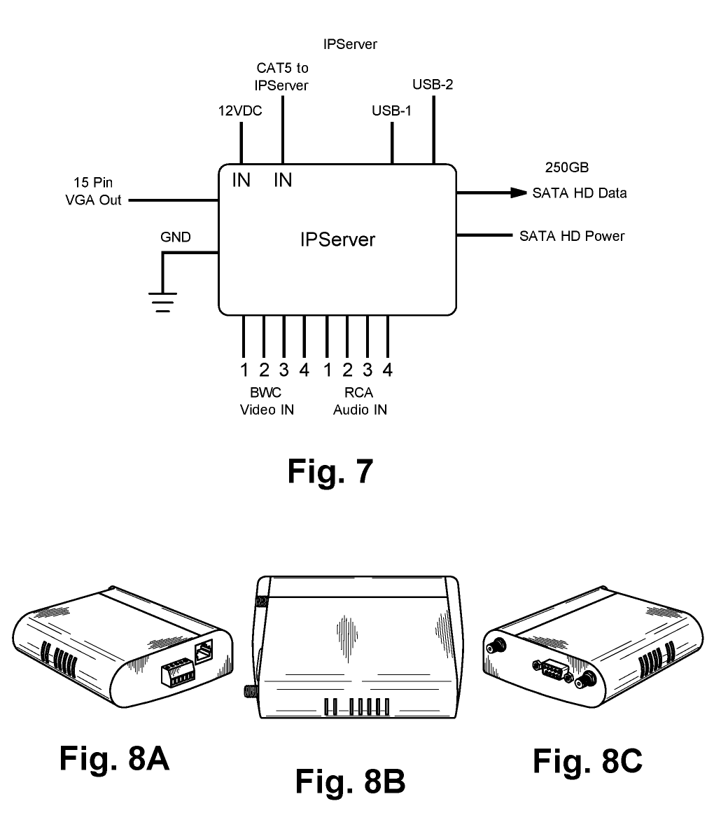

FIGS. 4 to 7 depict various electrical connectors, circuit diagrams, and dimensional characteristics, among other features of the main device. FIG. 4 depicts an example power plug with a 12′ 18 AWG Cord and 5 Amp Fuse that can be used for connecting the device to a cigarette lighter to provide power to the device. FIG. 5 depicts various power connectors. FIG. 6 depicts a power input circuit diagram showing how the power connectors are coupled to the buses. FIG. 7 depicts an input/output diagram for a video processor/server. One type of DVR that can be used is a Platinum CCTV DVR Series 9800. FIG. 8 depicts an example cellular modem that can be utilized with the system. One type of modem that can be utilized with the system is a Netcomm Wireless 4G LTE Light Industrial M2M Router Model# NWL-25-02. Other connectors and hook ups would be utilized, if needed or as desired.

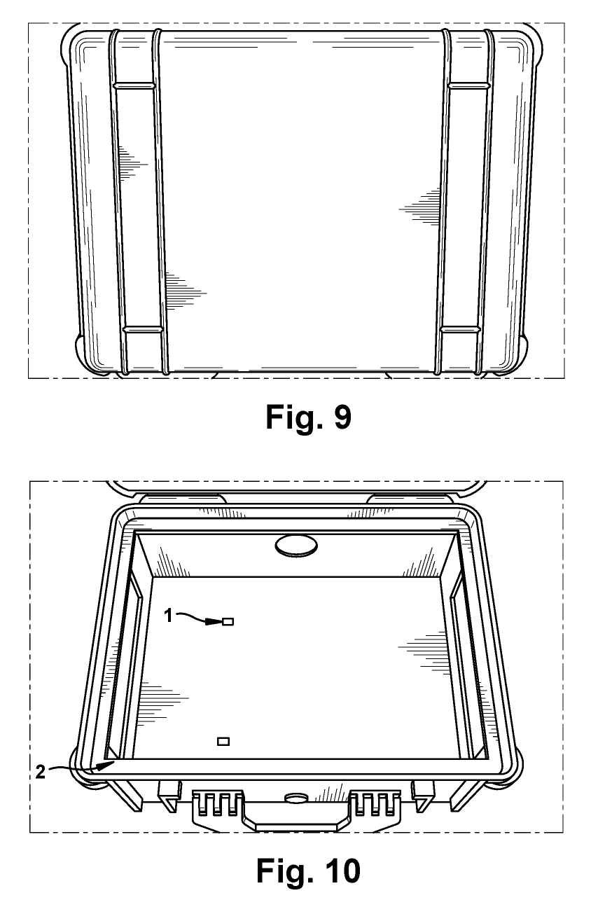

FIG. 9 depicts an example case that can be used as a housing for the main device. The example shown is a Pelican 1550 hard case. The top part of the housing includes holes for coupling the LCD screen to the housing. As shown in FIG. 10, the case is processed by first cutting holes in each side of the case. The holes are used for providing connector plates on the sides of the device. In addition, a hole may be cut in the back wall of the case to position a fan in the housing wall. Holes may be cut in the bottom of the case for holding the battery in position.

FIG. 11 depicts how a panel carrier can be installed inside the housing to hold and organize the various components of the device. The panel carrier includes openings for receiving components and wiring. The panel carrier may be coupled to the housing wall by using 4 self-tapping screws located under each of the front and rear latches and hinges. A cooling fan is installed in the rear hole of the bottom part of the housing. The cooling fan has a filter kit. The unit also includes a corrugated plastic battery/dvr/modem carrier.

FIG. 11 shows the battery 1, a battery retaining bracket 2, a ½″×5″ lag bolt and nut 3 for holding the battery retaining bracket in place, a voltage limiter board 4, a cellular modem cut out 5, and a corrugated plastic carrier 6. Velcro tape 7 can be positioned in the bottom of the modem carrier as well as at other locations. A bus bar 8 is installed a front end of the case. The bus bar may be a 24-place bus bar and it may be installed with hot glue. The battery may be a 22ah 12v battery. The voltage limiter board is used to cut off voltage to the battery and can be coupled to the battery with double sided tape.

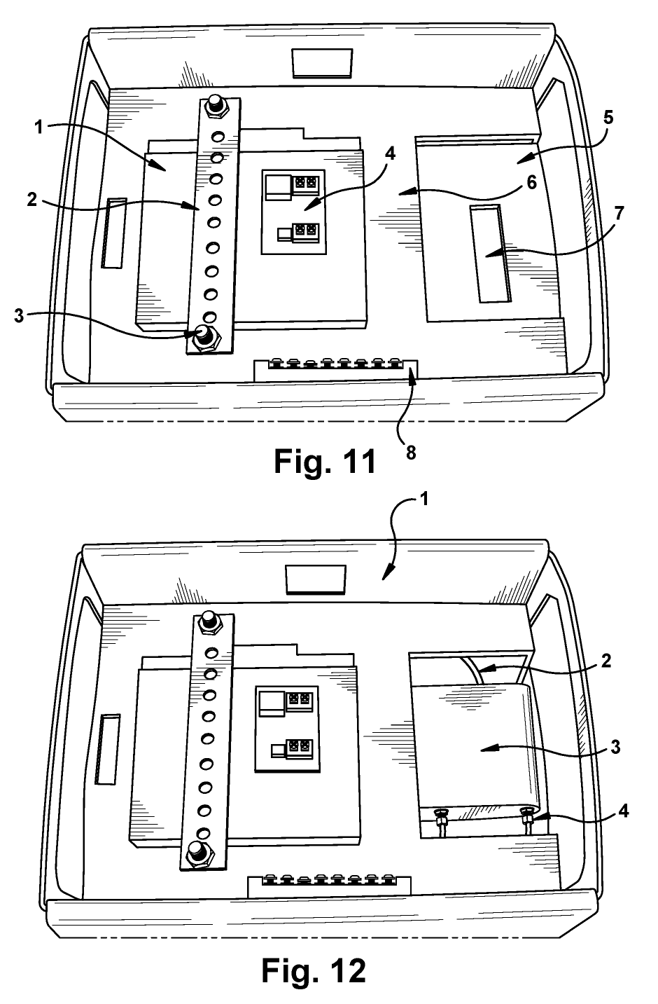

FIG. 12 shows the cellular modem 3 installed in the receiver. The 2″ cooling fan has wires 1 that are connected to the cellular modem for power. In addition, the cellular modem power wires 2 are coupled from the cellular modem to the battery. The cellular modem has wires 4 for the antennas.

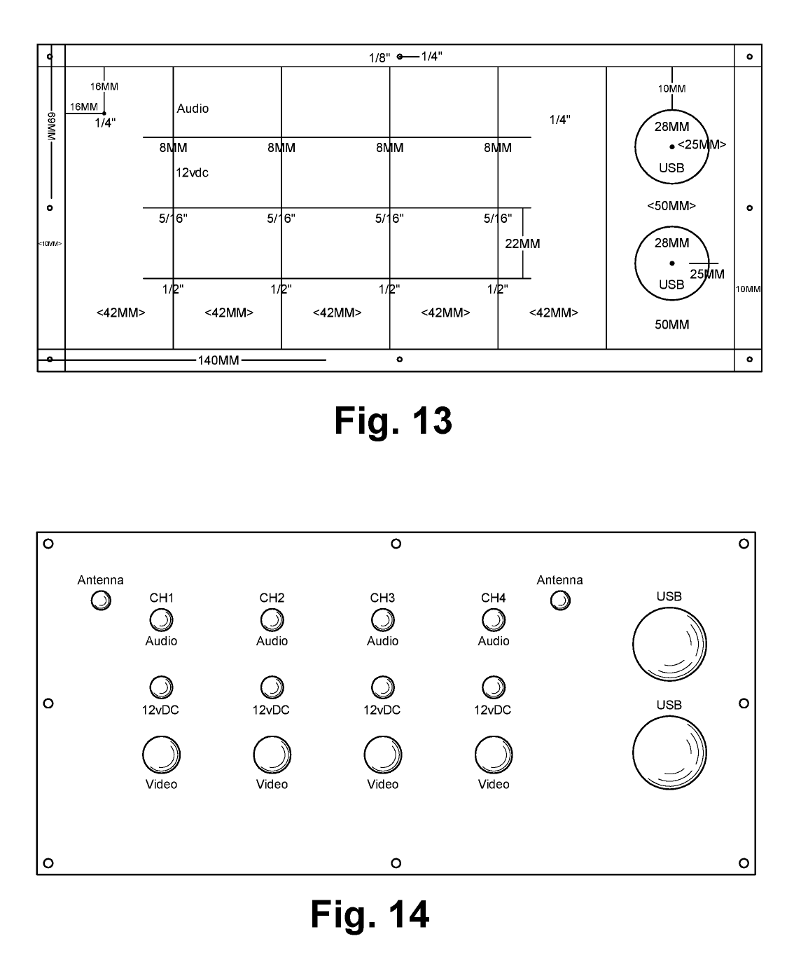

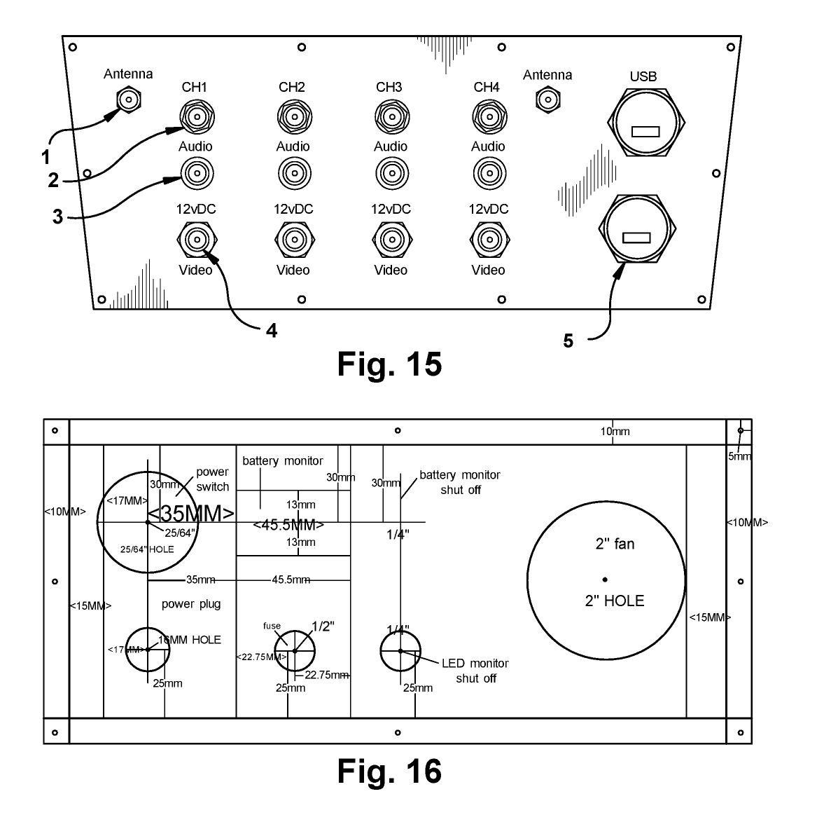

FIGS. 13-15 depict a left side connector plate. FIG. 13 shows the layout of the various connectors. FIG. 14 shows the openings in the plate after the openings have been cut into the plate. FIG. 15 shows the plate after its been covered with vinyl and the various connectors have been attached to the plate. The openings in the plate may be cut with water jetting or with other means. The plate can be made of steel or another material. FIG. 15 depicts cellular modem antenna bulk head connectors 1, audio bulk head connectors 2, power bulk head connectors 3, BNC bulk head connectors 4, and USB bulk head connectors 5.

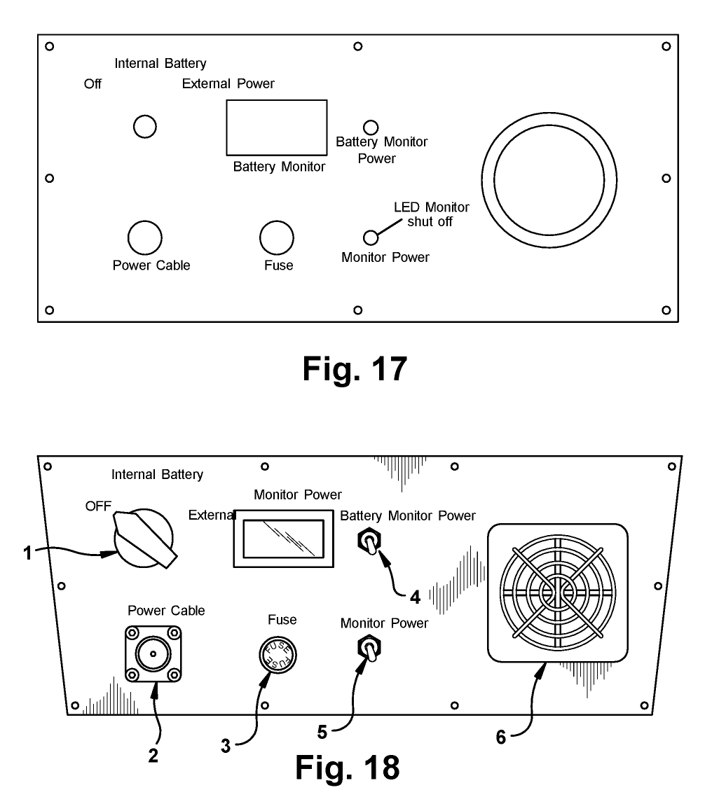

FIGS. 16-18 depict the right-side connector plate. FIG. 16 shows the layout of the various connectors. FIG. 17 shows the openings in the plate after the openings have been cut into the plate. FIG. 18 shows the plate after it has been covered with vinyl and the various connectors have been attached to the plate. In addition, FIG. 18 shows a second fan attached to the plate. FIG. 18 shows a power selector switch 1, a power input connector 2, a fuse holder 3, a battery monitor power switch, an LCD monitor power switch 5, and a 2″ fan with guard 6.

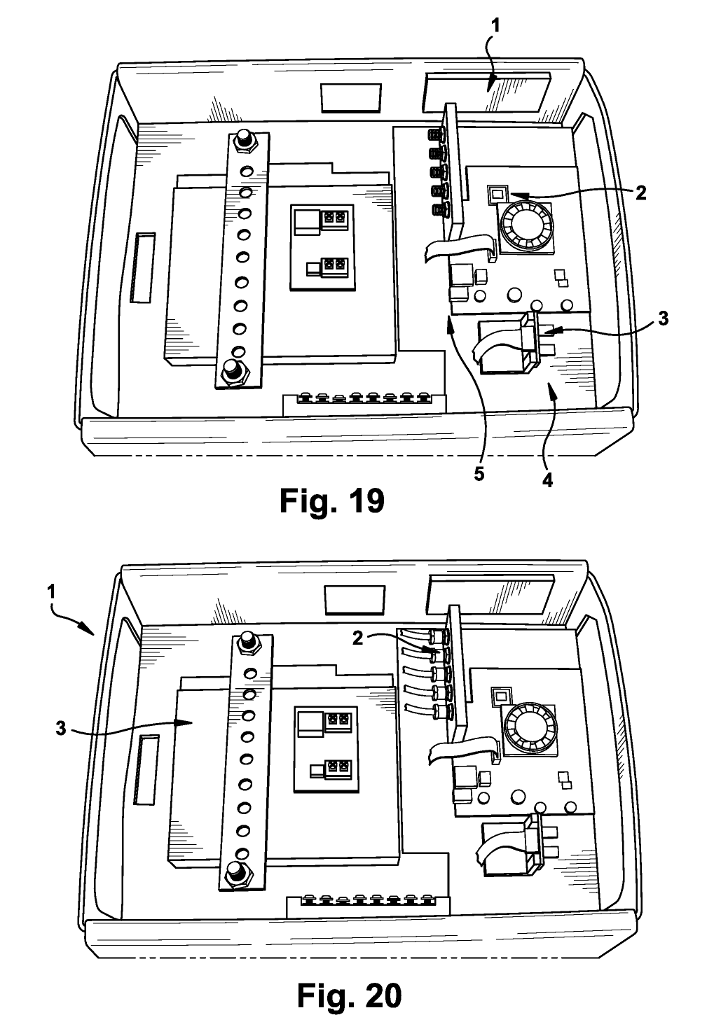

FIG. 19 depicts the interior of the bottom part of the case with further installations of components. In particular, FIG. 19 depicts a solid state hard drive 1, a DVR 2, a USB board for the DVR, a corrugated plastic lid for the cellular modem 4, and power for the DVR 5. The DVR 5 is installed over the corrugated plastic lid. Cables couple the DVR to the hard drive.

FIG. 20 depicts the interior of the bottom part of the case with further installations of components therein. The left side panel 1 is installed along with associated wiring. The audio and BNC cables 2 are shown as being connected to the DVR. The power wire 3 for the left side panel are coupled to power outputs.

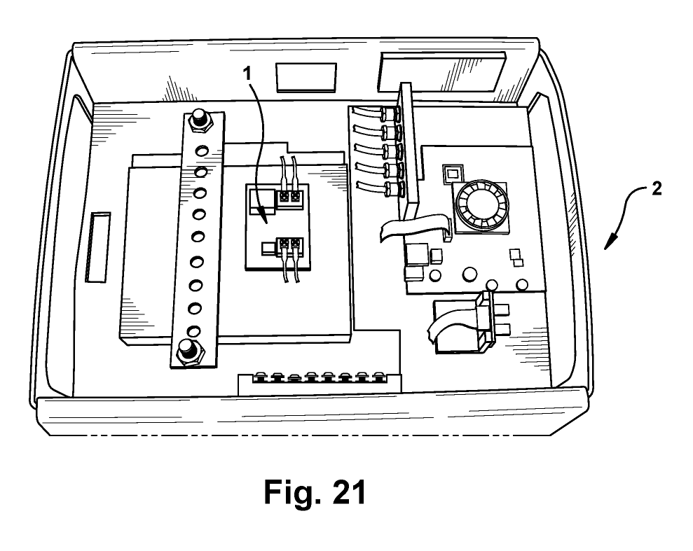

FIG. 21 depicts the interior of the bottom part of the case with installation of the right-side panel on the right side of the bottom part of the case. The battery voltage limiter 1 is hooked up to the battery. The right-side panel 2 is wired and installed. The right and left side plates are coupled to the housing with tapping screws. The battery is connected to the input side of the voltage limiter. Ground wires are coupled from the output of the voltage limiter to one of the bus bars. The bottom part of the housing is covered with a panel.

To operate the main device, the antennas are first coupled to the connectors labeled ANTENNA. Now you can attach the desired number of cameras to the unit, with each input channel being labeled VIDEO. The 12v DC is used to power the cameras and the AUDIO input is used for coupling to the audio output from the cameras. Four channels are shown, but additional channels could be provided, if desired.

The user then turns the power own for every power source needed. Battery is turned on if you want to run the internal battery. If the battery is fully charged, it should operate for 12-14 hours depending upon the current draw of the cameras attached. EXTERNAL is selected if you want to run the unit from the provided 12v DC car adaptor or the 110v adaptor. The user then turns on the BATTERY MONITOR POWER SWITCH and the MONITOR POWER SWITCH. These can be turned off and the lid closed when in use in the vehicle.

To access the main menu of the DVR, the USB mouse is connected to the USB connector and the user right clicks on the mouse. This will pull up a tool bar on the screen. Clicking on the far-left icon and will bring up the main menu. If you click on the second icon at the top of the menu screen, it will bring up the BACKUP & PLAYBACK menu. From here you can select the date and time on the right-hand side calendar. Once you have selected a date that has video on it you can select the time to start play back from the timeline in the center of the screen. Click on the play button above the timeline to start playback. To exit this mode, click on the x at the bottom right.

If the user clicks on the BACKUP tab on the left of the screen it will switch the screen to where you can off load the video saved on the hard drive. Click on the calendar in the top right next to START TIME. Select the date and click on the SEARCH button in the bottom right of the screen. This will produce a list of times and dates. These are the files that you can back up to a USB thumb drive. Select which files you want to back up by checking the box next to them. Now select the BACKUP button in the bottom right side of the menu. This take you to the screen where you can select the USB thumb drive you have inserted in the other USB port on the left side panel of the unit. You can also select which format you want it to off load as. *.AVI, *.H264, or *.WAVE. This screen also tells you the size of the file to be downloaded. Once you click on the START button it will copy the selected files to the USB thumb drive.

From the main menu select the top right icon to access the unique QR code for each unit. This will produce a QR code on the screen. The user can scan it with a QR reader from any tablet or phone and it will either take you to the ANDRIOD PLAY STORE or ITUNES to download the application. Once you have download the app, select the camera icon in the top right of the app and click on the+icon in the top right corner. This will bring up a DEVICE INFO page. Select the REGISTER TYPE and then select QR code. This will bring up a QR code scanner. Now scan the QR code on the screen of the unit once again. This will program your tablet/phone to the unit.

After programming your personal device, the monitor will take you to the CHANNEL SELECTED screen. Check the box next to your device and select START PREVIEW. This will take you to the LIVE screen. The bottom left icon selects how many windows you want to view. The camera icon on the bottom tool bar takes a snap shot of the live view. The icon next to that is used to start and stop recording the live feed to your local device. The next icon on the tool bar looks like 4 arrows. This controls the PTZ function of the cameras if available. The next icon is just a plain square. This stops the live feed of the select channel. The last is a little meter and this allows you to select the quality of the video feed.

A BNC connector (Bayonet Neill-Concelman) is a miniature quick connect/disconnect radio frequency connector used with coaxial cable. It features bayonet lugs on a female connector. Mating is achieved with a quarter turn of the coupling nut. BNC connectors are typically used with miniature-to-subminiature coaxial cable. A DVR (digital video recorder) is an electronic device that records video in a digital format to a disk drive, USB flash drive, SD memory card, SSD, or other local or networked mass storage device.

A surveillance apparatus includes a housing, a cellular modem, an antenna, one or more cameras, an input/output device, connectors, and a power source. The cellular modem is coupled to the housing. The antenna is coupled to the modem. The one or more cameras are coupled to a video processor/server for capturing data from the one or more cameras. The video processor/server is coupled to the modem to permit the transmission of data therefrom. The input/output device is coupled to the system for viewing video images and for communicating commands to the system. A plurality of external connectors is coupled to the housing and the video processor/server. The power source is for powering the cellular modem and the video processor/server. The surveillance apparatus permits a user to monitor a location remotely using the cellular modem.

The input/output device may include a monitor and a mouse. The video processor/server and cameras capture both video and audio. The system and apparatus may further include a hard drive coupled to the video processor/server for storing data. The system and apparatus may further include audio and BNC cables that are coupled to the video processor/server. The video processor/server may be a DVR.

The apparatus may be portable. At least some of the cameras may be remotely positioned relative to the housing. The one or more cameras may be powered by the power source of the apparatus, or the cameras may be independently battery powered, or a combination of both. When the cameras are battery powered, they have a range of about 150 feet from the surveillance apparatus and transmit data to the video processor/server.

The apparatus also includes a left side plate coupled to an external side of the housing and a right-side plate coupled to an external side of the housing, with said left and right side plates providing a location for external connectors. The external connectors may include one or more of a modem antenna connector, an audio bulk head connector, a power bulk head connector, a BNC bulk head connector, a USB bulk head connector, a power selector switch, a power input connector, a fuse holder, a battery monitor power switch, and an LCD monitor power switch.

The power source may be a battery pack. The battery pack may be retained in the housing by a battery retaining bracket and is removable and replaceable from the housing. A carrier may be positioned inside the housing for coupling to various components positioned inside the housing and for stabilizing the various components inside the housing.

The apparatus may further comprise at least one fan coupled to the housing for cooling components positioned inside the housing. A connector may be coupled to the hard drive for downloading data from the hard drive.

The system and apparatus described herein is described as having a cellular modem. This term is meant to encompass any type of modem or communication device that permits a user to communicate with the system, whether cellular or not. The system includes appropriate software that is utilized to make the system run properly. Additional circuit boards or electronic equipment may be utilized to allow for proper operation of the apparatus and system, as known by those of skill in the art.

While the example device is described as being a portable device, it could be a non-portable device. While the modem is described as a cellular modem, it could be a different type of modem or could be hard wired.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

What is claimed is:

1. A surveillance apparatus comprising:
a housing;
a cellular modem coupled to the housing;
an antenna coupled to the modem;
one or more cameras coupled to a video processor/server for capturing data from the one or more cameras, said video processor/server coupled to the modem to permit the transmission of data therefrom;
an input/output device coupled to the system for viewing video images and for communicating commands to the system;
a plurality of external connectors coupled to the housing and the video processor/server; and
a power source for powering the cellular modem and the video processor/server,
wherein the surveillance apparatus permits a user to monitor a location remotely using the cellular modem.

2. The apparatus of claim 1, wherein the input/output device includes a monitor and a mouse.

3. The apparatus of claim 1, wherein the video processor/server and cameras capture both video and audio.

4. The apparatus of claim 1, further comprising a hard drive coupled to the video processor/server for storing data.

5. The apparatus of claim 1, further comprising audio and BNC cables that are coupled to the video processor/server, wherein the video processor/server is a DVR.

6. The apparatus of claim 1, where in the apparatus is portable.

7. The apparatus of claim 1, wherein at least some of the cameras are remotely positioned relative to the housing.

8. The apparatus of claim 1, wherein the one or more cameras are powered by the power source of the apparatus, the cameras are independently battery powered, or a combination of both.

9. The apparatus of claim 8, wherein when the cameras are battery powered, they have a range of about 150 feet from the surveillance apparatus and transmit data to the video processor/server.

10. The apparatus of claim 1, further comprising a left side plate coupled to an external side of the housing and a right-side plate coupled to an external side of the housing, with said left and right side plates providing a location for external connectors.

11. The apparatus of claim 10, wherein the external connectors include one or more of a modem antenna connector, an audio bulk head connector, a power bulk head connector, a BNC bulk head connector, a USB bulk head connector, a power selector switch, a power input connector, a fuse holder, a battery monitor power switch, and an LCD monitor power switch,

12. The apparatus of claim 1, wherein the power source is a battery pack.

13. The apparatus of claim 13, wherein the battery pack is retained in the housing by a battery retaining bracket and is removable and replaceable from the housing.

14. The apparatus of claim 1, further comprising a carrier positioned inside the housing for coupling to various components positioned inside the housing and for stabilizing the various components inside the housing.

15. The apparatus of claim 1, further comprising at least one fan coupled to the housing for cooling components positioned inside the housing.

16. The apparatus of claim 4, further comprising a connector coupled to the hard drive for downloading data from the hard drive.
